(19) United States
(12) Patent Application Publication
(10) Pub. No.: US 2018/0299395 A1
(43) Pub. Date: Oct. 18, 2018

(54) NOX GAS SENSOR

(71) Applicant: ROYAL MELBOURNE INSTITUTE OF TECHNOLOGY, Melbourne, Victoria (AU)

(72) Inventors: Kourosh KALANTAR-ZADEH, Albert Park (AU); Jian Zhen OU, Chadstone (AU); Nam HA, Maidstone (AU); Yongxiang LI, Clayton (AU)

(73) Assignee: ROYAL MELBOURNE INSTITUTE OF TECHNOLOGY, Melbourne, Victoria (AU)

(21) Appl. No.: 15/735,626

(22) PCT Filed: Jun. 10, 2016
(86) PCT No.: PCT/AU2016/000199

§ 371 Date: Dec. 12, 2017

(30) Foreign Application Priority Data
Jun. 12, 2015 (AU) 2015902219

(51) Int. Cl. G01N 27/12

(52) U.S. Cl. CPC G01N 27/127

(57) ABSTRACT

This invention provides a highly-selective and sensitive Nitrogen oxide gas sensor based on the resistive transducing platforms using two-dimensional (2D) tin disulphide (SnS₂) flakes that can operate below 150° C. This sensor operates based on the physisorption of nitrogen oxide on the surface of the sensitive layer. The fabrication of the sensors is low-cost. The tin disulphide is preferably produced by reacting tin dichloride at elevated temperature with powdered sulphur in a liquid phase to form tin disulphide nano particles and separating the tin disulphide nano particles from the liquid phase.

### BACKGROUND TO THE INVENTION

Nitrogen dioxide (NO₂) is an industrially and biologically important gas that is mostly released during the combustion of fossil fuels. This gas can be particularly dangerous and at levels greater than 1 ppm, causing damage to the human respiration system and worsening respiratory diseases. NO₂ is also a recognized air pollutant. It plays an important role in the chemistry of the atmosphere, contributing to the formation of ozone (O₃), which is the major cause of photochemical smog and acid rain.

NO₂ is an important material for the synthesis of nitric acid that is used in the production of fertilisers and explosives for both military and mining uses. Furthermore, NO₂ is an essential gas for many biosystems, as nitrogen monoxide (NO) appears as a gasotransmitter in many cell signalling paths can convert to NO₂ rapidly in the presence of environmental perturbance. As such, the sensing of nitrogen oxides (NOx, a group mainly consists of NO₂ and NO) can be potentially implemented as a diagnostic process. For instance, the detection of NOx in exhaled breath (at the ppb level) is helpful for identifying infections of lung tissus. In addition, the NOx can possibly be used as a biomarker for some of the gastrointestinal disorder symptoms such as irritable bowel disease (IBD).

The current NO₂ gas sensor technologies can be categorized into chemiluminescent, electrochemical, resistive, and optical detection.

The patents of U.S. Pat. No. 4,236,895 and WO1999053297 reported chemiluminescent sensors for NO₂ detection. In brief, the sensing mechanism relies on the reaction of NO with O₃ to produce an excited form of NO₂. As the excited molecule returns to its ground state, fluorescent radiation is emitted. The intensity of the light is proportional to the concentration of NO. These sensors are bulky and need gas converters that can be used to convert NO₂ catalytically to NO, making them expensive and relatively cumbersome for many applications.

The patents of U.S. Pat. No. 5,906,718 and EP1688736 reported NO₂ sensors that are based on the use of electrochemical cells. The operation principle relies on the electrochemical reduction of NO₂ between two electrodes immersed in a liquid electrolyte reservoir. NO₂ passes through a capillary diffusion barrier into the reaction cell, where it is reduced at the working electrode. The migrating electrons produced by the reaction result in a net current flow, which is proportional to the NO₂ concentration. However, these sensors are poorly selective and have cross-talk to other possibly co-existing gases (e.g. H₂ gas in the automotive industry and clinical diagnostics). In addition, the operation lifetime of the sensors are very short (3-6 months), which potentially increases the maintenance cost of sensing system. The poor gas selectivity and short lifetime issues can be improved by using zirconia-based solid electrolytes (U.S. Pat. No. 6,413,397 and U.S. Pat. No. 6,843,900). These sensors can also operate in the oxygen-free environment. However, their operation temperatures are usually very high (in the range of 500-900° C.), which results in high operation costs. It is generally energy inefficient, limiting their applications to combustion and automotive monitoring systems.

Non-dispersive infrared sensing of NO₂ is another highly selective gas sensing method (U.S. Pat. No. 6,469,303), which relies on the unique infrared light absorption fingerprint of NO₂ gas molecules. Nevertheless, it needs a long enough interaction pathway between the gas molecules and infrared light beam otherwise its sensitivity will be greatly degraded. This makes them bulky and expensive. As smaller sizes, the general detection limit of these sensors is within the ppth range (part per thousand), which is not suitable for most of the applications.

Another common NO₂ sensors are the chemiresistor type based on semiconducting metal oxides (U.S. Pat. No. 7,704,214 and U.S. Pat. No. 8,758,261), such as tin oxide (SnO₂), tungsten oxide (WO₃) and zinc oxide (ZnO). In these sensors, the gas diffuses into the oxide and modulates the grain boundary resistances by transferring charge carriers from the semiconductor to the adsorbed species. However, the surface affinity of these metal oxide materials is also high to gas species other than NO₂, making these sensors poorly selective. Furthermore, the presence of oxygen is crucial during the operation, which will not be suitable for some particular applications with the need of oxygen-free environment such as the gastrointestinal tracts and fermentation chambers. Finally in order to improve the response and recover kinetics of the sensors, the operation temperatures are usually high (>200° C.). The recent replacement with carbon nanotube (CNT) and graphene (US20140103330, U.S. Pat. No. 8,178,157 and CN104181209) can significantly reduce the consumption of energy and oxygen. Nevertheless, the issue of poor gas selectivity has yet been addressed. Additionally, CNT and graphene based devices are generally not reversible sensors without extensive surface functionalization.

It is an object of this invention to provide a nitrogen sensor that can operate at lower temperatures.

It is another object of this invention to provide a gas sensor that shows selectivity for nitrogen oxides.

### BRIEF DESCRIPTION OF THE INVENTION

To this end this invention provides a nano structured tin disulphide nitrogen oxide gas sensor.

This nanostructured gas sensor demonstrates selectivity for NOx and can operate at temperatures below 150° C. The sensor operation is based on the physisorption of nitrogen oxide on the surface of the sensitive layer.

There is no selective NO₂ gas sensors available in the market or reported in literature that are highly sensitive and can operate reliably at relatively low temperatures regardless of the presence of ambient oxygen. This invention provides a highly-selective and sensitive NO₂ gas sensor based on the resistive transducing platforms using two-dimensional (2D) tin disulphide (SnS₂) flakes that can operate below 150° C. The fabrication of the sensors is low-cost.

The tin disulphide is preferably produced by reacting tin dichloride at elevated temperature with powdered sulphur in a liquid phase to form tin disulphide nano particles and separating the tin disulphide nano particles from the liquid phase.

### DETAILED DESCRIPTION OF THE INVENTION

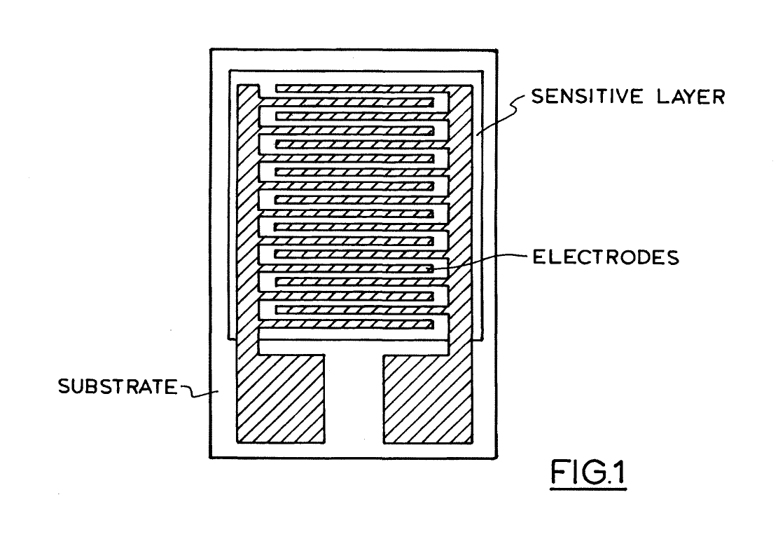

A preferred embodiment of the invention will be described in which FIG. 1 is schematic representation of the sensor of this invention;

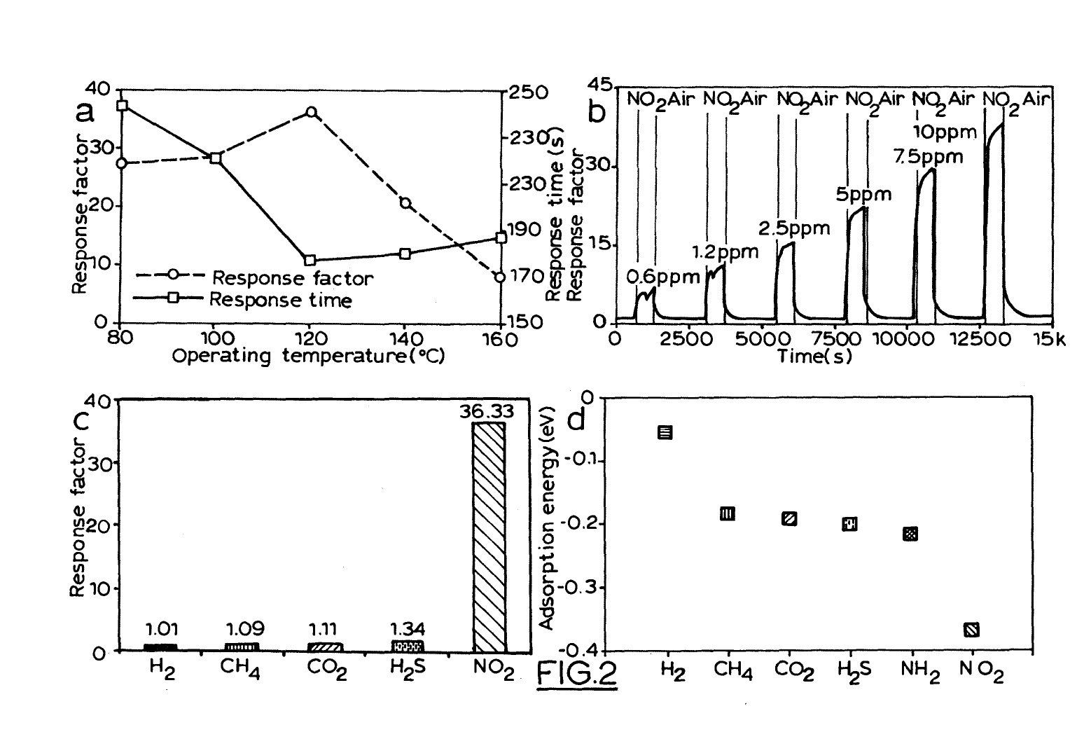

FIG. 2 illustrates the gas sensing response of 2D SnS₂ flakes.

To synthesize nanostructured SnS₂ flakes, many methods can be used. Methods that make large surface to volume ratio are the most suitable for making gas sensors and generally two dimensional materials (2D) fall into this category. A 2D structure is atomically thin and the lateral dimension is much larger than this thickness. An example for the synthesis of 2D SnS₂ is presented here. Tin chloride (SnCl₄.5H₂O, 0.5 mM) can be added to a mixture of oleic acid (OAc-5 mL) and octadecene (ODE-10 mL) in a 100 mL three-neck flask to produce tin precursor. A standard Schlenk line can be used to protect the reaction from oxygen and moisture under a flow of high-purity N₂. The mixed solution can be degassed at >100° C. for a while to remove moisture and oxygen. Subsequently, the solution is stirred at elevated temperature. Then, sulphide powder can be injected into the reaction system. After cooling the solution to room temperature, the SnS₂ flakes can be collected and separated from the solution by centrifugation.

The gas sensor is shown in FIG. 1.

The 2D SnS₂ gas sensors are fabricated by drop-casting the solution containing 2D SnS₂ flakes on the resistive transducing substrates (FIG. 1). The substrates are made of alumina with surface input interdigitated transducer (IDT) patterns. The resistance of the device is measured using a multimeter and the gas response factor is calculated using R_{g}/Rₐ for R_{g}>Rₐ, or Rₐ/R_{g} for R_{g}<Rₐ, where Rₐ and R_{g} represent the resistances of the device to air and the analyte gas, respectively. We tested the operation temperature of sensors from that of room to 160° C. For the temperatures lower than 80° C., the device does not show acceptable recovery/recovery time and additionally R_{g} is very large, while there is an observable transition from SnS₂ to sub-stoichiometric tin oxides (SnOₓ) when the operation temperature exceeds 180° C.

FIG. 2 shows the gas sensing response of the sensor of this invention. The response factor and response time of sensors made of 2D SnS₂ flakes in the presence of 10 ppm NO₂ in synthetic air balance as a function of operation temperature; b. The dynamic sensing performance of 2D SnS₂ flakes toward NO₂ gas with the concentrations ranged from 0.6 to 10 ppm at the operation temperature of 120° C.; c. The cross-talk of 2D SnS₂ flakes towards H₂ (1%), CH₄ (10%), CO₂ (10%), H₂S (56 ppm) and NO₂ (10 ppm); d. The calculated molecule-surface adsorption energies of 2D SnS₂ flakes towards the aforementioned gases together with NH₃.

TABLE 1
The gas sensing performance of 2 D SnS₂ flakes
toward 10 ppm NO₂ at different temperatures

| Operation | | | |
|---|---|---|---|
| temperature | Response | Response | Recovery |
| (° C.) | factor | time (s) | time (s) |
| 80 | 27.2 | 243 | 723 |
| 100 | 28.7 | 220 | 358 |
| 120 | 36.3 | 172 | 138 |
| 140 | 20.7 | 180 | 115 |
| 160 | 8.2 | 187 | 98 |

From FIG. 2a and Table 1, the initial response factor of the sensor at 80° C. after the exposure of 10 ppm NO₂ in synthetic air balance is found to be ˜28, indicating the resistance of the device after NO₂ gas exposure is approximately 28 times larger than that in the presence of synthetic air. In this case, the surface adsorbed NO₂ gas molecule acts as an electron acceptor and accepts electrons from 2D SnS₂ flakes. Such a charge reduces the number of free electrons in the flake, thus increasing its resistance. The response factor is enhanced as well as the response and recovery time are decreased with the increase of operation temperature for up to 120° C., suggesting that the increase of operation temperature facilitates the adsorption of NO₂ gas molecules onto the 2D SnS₂ surface. However when further increasing the operation temperature beyond 120° C., the response factor is dramatically dropped and the response time is slightly increased, implying that the surface desorption process of NO₂ gas becomes comparable to its adsorption process at such elevated temperatures. The dynamic performance of the sensor towards NO₂ gas with concentrations ranged from 0.6 to 10 ppm at the optimum operation temperature of 120° C. is also investigated and shown in FIG. 2b. With the increase in the concentration of NO₂, more charges are transferred from SnS₂ to NO₂. The charges are transferred to different NO₂ molecules as the concentration increases. The measured response factor of the sensor is observed to be almost linear with the exposure concentrations of NO₂ gas, while the response and recovery time are gradually decreased and eventually reach the saturation stage when the NO₂ concentration exceeds 2.5 ppm (Table 2).

TABLE 2
The gas sensing performance of
2 D SnS₂ flakes toward different
concentrations of NO₂.

| NO₂ | | | |
|---|---|---|---|
| concentration | Response | Response | Recovery |
| (ppm) | factor | time (s) | time (s) |
| 0.6 | 6.7 | 317 | 465 |
| 1.2 | 10.8 | 182 | 181 |
| 2.5 | 15.1 | 162 | 144 |
| 5 | 22.1 | 169 | 145 |
| 7.5 | 30.0 | 170 | 139 |
| 10 | 36.3 | 172 | 138 |

The NO₂ gas sensing performance of SnS₂ flakes is highly selective as only minimal responses toward other gases, including H₂ (1%), CH₄ (10%), CO₂ (10%) and H₂S (56 ppm), are observed compared to that of NO₂ (FIG. 2c).

To understand such a unique response of 2D SnS₂ flakes toward NO₂ gas, we calculated the molecule-surface binding energies using density function theory to calculate the dispersion forces, which are shown in FIG. 2d and Table 3.

TABLE 3
The calculated molecule-surface
adsorption energies of 2 D SnS₂
flakes towards H₂, CH₄, CO₂,
H₂S, NH₃, NO₂ and O₂.

| | Binding |
|---|---|
| Molecule | energy (eV) |
| CH₄ | −0.182 |
| CO₂ | −0.191 |
| H₂ | −0.053 |
| H₂S | −0.199 |
| NH₃ | −0.215 |
| NO₂ | −0.367 |
| O₂ | 1.430 |

The closest distance between the molecules and the surface, for the bound species, ranged from 2.17 to 2.87 Å which is within the typical range for physisorped molecules. The values of the binding energies also indicate the physisorption has occurred between the molecule and the surface for CH₄, CO₂, H₂S, NH₃ and NO₂, with NO₂ being the most strongly bound species. The binding energy for NO₂ is approximately 140 meV greater than for the next most bound species (NH₃), while H₂ and O₂ are non-binding due to its relatively small adsorption energy (˜50 meV) and positive adsorption energy (Table 3), respectively. The calculated surface binding energies toward different gas molecules are in accordance with the measurement results, confirming that the impressive NO₂ gas response of 2D SnS₂ flakes is originated from its unique physical surface affinity to the gas molecules. FIG. 2 shows the gas sensing response of the sensor of this invention. The response factor and response time of sensors made of 2D SnS2 flakes in the presence of 10 ppm NO2 in synthetic air balance as a function of operation temperature; b. The dynamic sensing performance of 2D SnS₂ flakes toward NO₂ gas with the concentrations ranged from 0.6 to 10 ppm at the operation temperature of 120° C.; c. The cross-talk of 2D SnS2 flakes towards H₂ (1%), CH₄, (10%), CO₂ (10%), H₂S (56 ppm) and NO₂ (10 ppm); d. The calculated molecule-surface adsorption energies of 2D SnS₂flakes towards the aforementioned gases together with NH₃.

From the above it can be seen that this invention provides a gas sensor with good selectivity for nitrogen oxide gases and which is able to operate at low temperatures.

Those skilled in the art will appreciate that this invention can be implemented in embodiments other than those described without departing from the core teachings of this invention.

1. A nitrogen oxide gas sensor which includes nano structured tin disulphide.

2. A gas sensor as claimed in claim 1 which consists of a transducing platform incorporating two-dimensional (2D) tin disulphide (SnS₂) flakes.

3. A gas sensor as claimed in claim 2 in which the transducing platform consists of resistive transducing substrates made of alumina with surface input interdigitated transducer (IDT) patterns.

4. A gas sensor as claimed in claim 1 in which the tin disulphide nano particles are produced by reacting tin dichloride at elevated temperature with powdered sulphur in a liquid phase to form tin disulphide nano particles and separating the tin disulphide nano particles from the liquid phase.
